(19) United States
(12) Patent Application Publication
(10) Pub. No.: US 2017/0205059 A1
(43) Pub. Date: Jul. 20, 2017

(54) LIGHTING ARRANGEMENT

(71) Applicant: Kuzco Lighting, SURREY (CA)

(72) Inventor: Shaokun Yang, Surrey (CA)

(73) Assignee: Kuzco Lighting, SURREY (CA)

(21) Appl. No.: 15/079,734

(22) Filed: Mar. 24, 2016

Related U.S. Application Data
(63) Continuation-in-part of application No. 29/551,875, filed on Jan. 18, 2016.

(51) Int. Cl. F21V 21/104; F21V 3/02

(52) U.S. Cl. CPC F21V 21/104; F21V 3/023

(57) ABSTRACT

A lighting arrangement can include a first and second lighting units. Each lighting unit can include a light emitting member, a wire assembly, and a pendant. The socket members can receive the light emitting members. The wire assemblies can extend from the socket members and be configured to communicate electricity to the respective light emitting members through the respective socket members. The pendant can surround the respective light emitting members. Each wire assembly can be configured to support the respective light emitting member, socket member, and pendant in a suspended orientation, such as from ceiling. Each of the pendants can have portions of different opacity including respective first and second portions. The first portions can be more opaque than the second portions. The first wire assembly can pass through the first portion and the second wire assembly can pass through the second portion.

### CROSS-REFERENCE TO RELATED APPLICATIONS

This application claims the benefit of U.S. Design patent application Ser. No. 29/551,875 for a LIGHTING ENCLOSURE, filed on 18 Jan. 2016, which is hereby incorporated by reference in its entirety.

### BACKGROUND

1. Field

The present disclosure relates to a light-emitting device.

2. Description of Related Prior Art

U.S. Pat. No. 4,214,296 discloses a ROTATABLE LAMP FIXTURE. The rotating lamp fixture includes a spherical shell member rotatably supported on a vertically extending support member, a platform disposed in the shell member, a drive motor mounted on the platform, a stationary gear secured to a vertical support member, the shell member being rotatably mounted on the support member, the motor being drivingly connected to the stationary gear and being effective when energized to rotate the platform and the shell in which it is supported about the vertical support member, and a light bulb socket member suspended within the shell member.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A lighting arrangement can include a first lighting unit and a second lighting unit. The first lighting unit can include a first light emitting member, a first wire assembly, and a first pendant. The first socket member can receive the first light emitting member. The first wire assembly can extend from the first socket member and can be configured to communicate electricity to the first light emitting member through the first socket member. The first pendant can surround the first light emitting member. The first wire assembly can be configured to support the first light emitting member, the first socket member, and the first pendant in a suspended orientation. The first pendant can have portions of different opacity including a first portion and a second portion. The first portion can be more opaque than the second portion. The first wire assembly can pass through the first portion. The second lighting unit can include a second light emitting member, a second socket member, a second wire assembly, and a second pendant. The second socket member can receive the second light emitting member. The second wire assembly can extend from the second socket member and can be configured to communicate electricity to the second light emitting member through the second socket member. The second pendant can surround the second light emitting member. The second wire assembly can be configured to support the second light emitting member, the second socket member, and the second pendant in a suspended orientation. The second pendant can have portions of different opacity including a first portion and a second portion. The first portion can be more opaque than the second portion. The second wire assembly can pass through the second portion.

### BRIEF DESCRIPTION OF THE DRAWINGS

The detailed description set forth below references the following drawings:

FIG. 1 is a perspective view of an exemplary embodiment of the present disclosure;

FIG. 2 is a cross-sectional view taken through a center plane of a lighting unit according to an exemplary embodiment of the present disclosure;

FIG. 3 is a perspective view of another exemplary embodiment of the present disclosure;

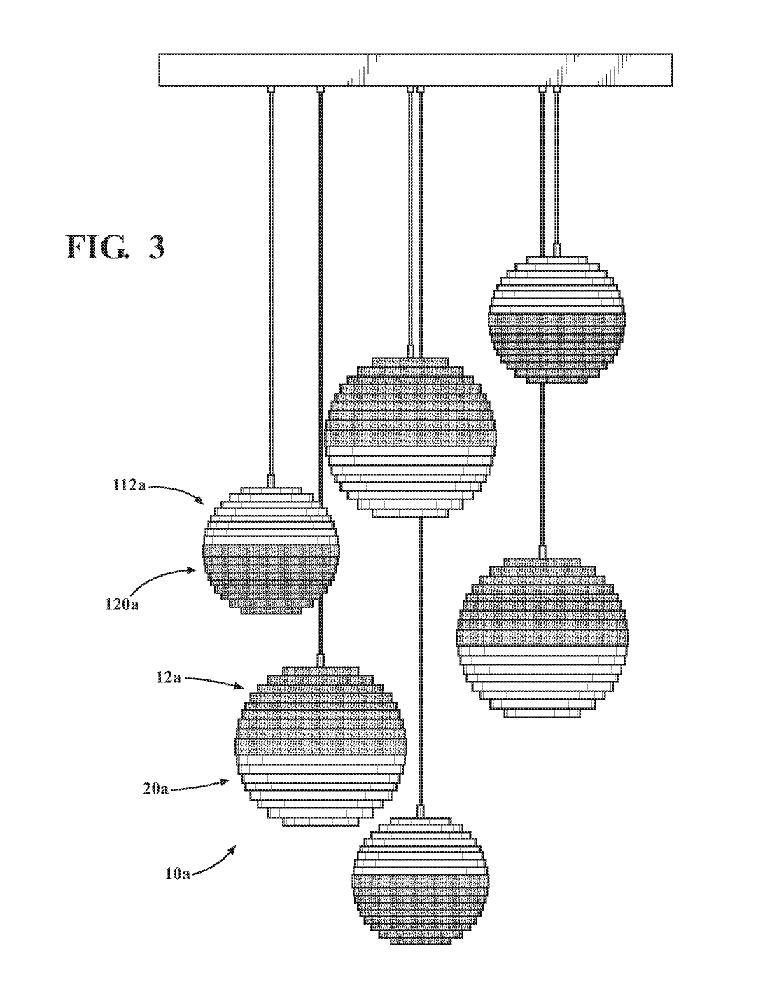

FIG. 4 is a perspective view of another exemplary embodiment of the present disclosure; and

FIG. 5 is a perspective view of another exemplary embodiment of the present disclosure partially disassembled.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide an enhanced lighting arrangement. The lighting arrangement can include lighting units having portions of different opacity. The portions of different opacity are alternatively arranged to enhance the diffusion of light. A first lighting unit can have a less opaque portion directed downward while an adjacent, second lighting unit can have a less opaque portion directed upward. Light from the second lighting unit can reflect off of a ceiling and walls. The area below the lighting units is thus provided with direct light and reflected light and this combination has been found to be superior.

Opacity is a scale defining the extent to which light can pass through an object. At one end of the spectrum are fully transparent bodies. A completely or fully transparent structure is a structure through which light can pass without meaningful loss of strength or intensity. A window is an example of a transparent structure. At the opposite end of the spectrum are fully opaque bodies. Light cannot pass through an opaque structure with meaningful strength; to the human eye light does not appear to pass through an opaque structure. A translucent structure is neither fully transparent nor opaque. A translucent structure permits light to pass through but diffuses the light so that objects on one side of the structure are not clearly visible on the other side of the structure. More light can pass through a first structure that is more translucent than a second structure. The second structure is more opaque than the first structure.

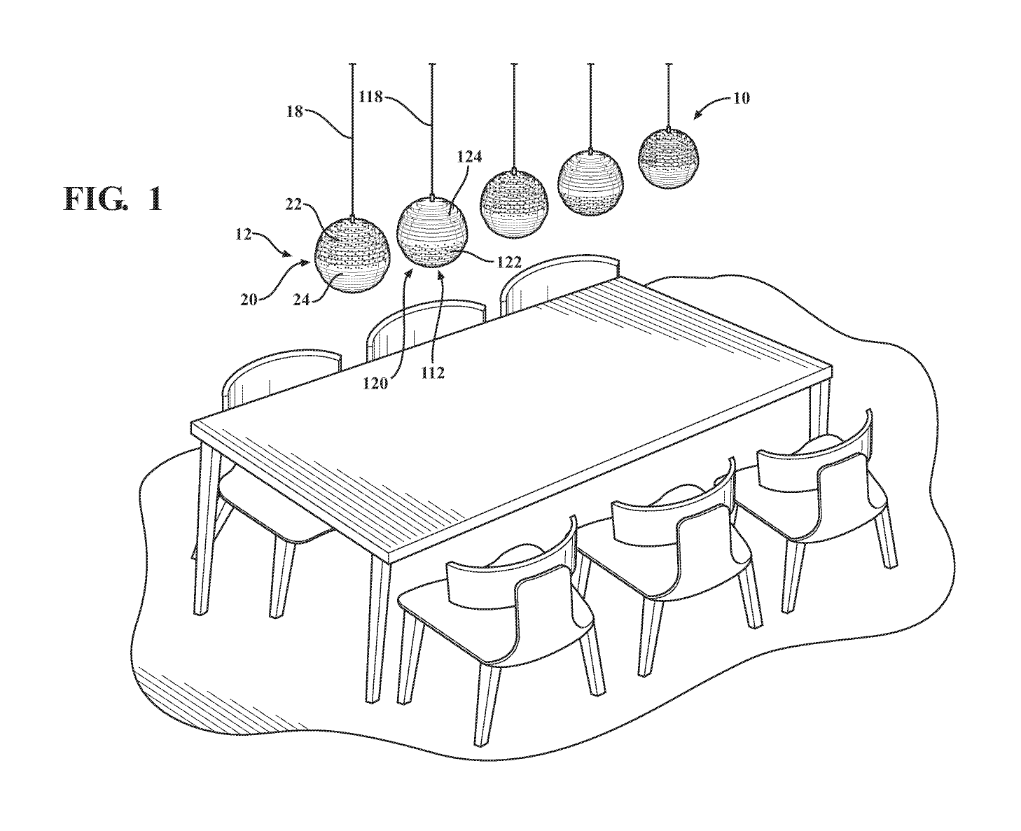

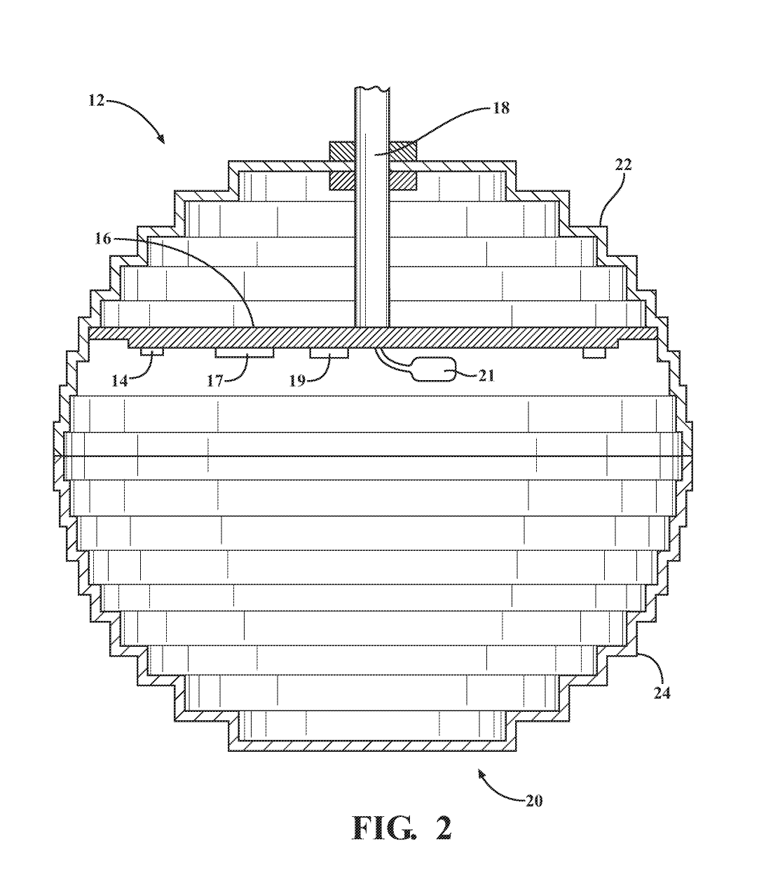

Referring now to FIGS. 1 and 2, a lighting arrangement 10 can include a first lighting unit 12 and a second lighting unit 112. As best shown in FIG. 2, the first lighting unit 12 can include a first light emitting member 14, a first socket member 16, a first wire assembly 18, and a first pendant 20. The first light emitting member 14 is shown as a light emitting diode, but the first light emitting member can take any form in various implementations of the present disclosure, including bulbs. The exemplary socket member 16 includes a circuit board on which the light emitting diode 14 is mounted. The socket member 16 can also support other circuit elements, such as one or more integrated circuits 17, a resistor 19 and a capacitor 21. In other embodiments of the present disclosure, the socket member can be a traditional socket that receives a bulb.

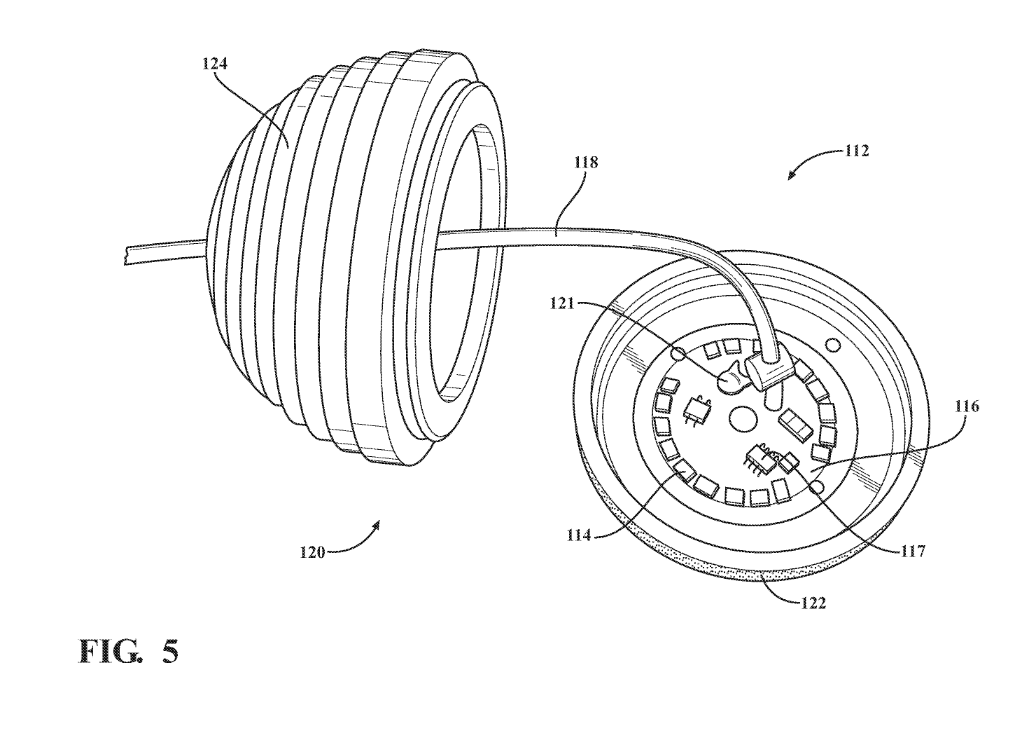

As best shown in FIG. 5, the second lighting unit 112 can include a second light emitting member 114, a second socket member 116, a second wire assembly 118, and a second pendant 120. The second light emitting member 114 is shown as a light emitting diode, but the second light emitting member can take any form in various implementations of the present disclosure, including bulbs. The exemplary socket member 116 includes a circuit board on which the light emitting diode 114 is mounted. The socket member 116 can also support other circuit elements, such as one or more integrated circuits 117 and a capacitor 121. In other embodiments of the present disclosure, the socket member can be a traditional socket that receives a bulb.

The first socket member 16 can receive the first light emitting member 14. The first socket member 16 and the first light emitting member 14 can interconnected, such as through threads. The first wire assembly 18 can extend from the first socket member 16 and can be configured to communicate electricity to the first light emitting member 14 through the first socket member 16. The term “socket member” is used to refer to any structure for interconnecting a light emitting member with a wire delivering electrical power to the light emitting member. The first socket member 16 can include any desired structure associated with the delivery of electrical power, such a circuit board and/or an ac-dc converter.

The first pendant 20 can surround the first light emitting member 14. The first wire assembly 18 can be configured to support the first light emitting member 14, the first socket member 16, and the first pendant 20 in a suspended orientation, such as from a ceiling. FIG. 1 shows the first light emitting member 14, the first socket member 16, and the first pendant 20 suspended with the first wire assembly 18. The first pendant 20 can have portions of different opacity including a first portion 22 and a second portion 24. The first portion 22 can be more opaque than the second portion 24. The components of the lighting unit 12 can be arranged such that the first wire assembly 18 passes through the first portion 22, the darker portion.

Referring again to FIG. 1, the second lighting unit 112 can include a second light emitting member (not visible), a second socket member (not visible), a second wire assembly 118, and a second pendant 120. The second socket member can receive the second light emitting member in a manner similar to the engagement between the first socket member 16 and first light emitting member 14. The second wire assembly 118 can extend from the second socket member and can be configured to communicate electricity to the second light emitting member through the second socket member. The second pendant 120 can surround the second light emitting member. The second wire assembly 118 can be configured to support the second light emitting member, the second socket member, and the second pendant 120 in a suspended orientation. FIG. 1 shows the second light emitting member, the second socket member, and the second pendant 120 suspended with the second wire assembly 118. The second lighting unit 112 is spaced from the first lighting unit 12 along a horizontal axis, such as can extend along the surface of a ceiling. The second pendant 120 can have portions of different opacity including a first portion 122 and a second portion 124. The first portion 122 is more opaque than the second portion 124. The second wire assembly 118 can pass through the second portion 124.

In various implementations of the present disclosure, a lighting arrangement can include lighting units having pendants of various sizes. In the implementation shown in FIG. 1, the lighting units 12 and 112 respectively include pendants 20 and 120 that are substantially similarly sized, within manufacturing tolerances. The lighting arrangement 10a shown in FIG. 2 includes lighting units 12a with pendants 20a and lighting units 112a with pendants 120a. The pendants 20a and the pendants 120a are differently sized. The pendants 20a are larger than the pendants 120a.

In various implementations of the present disclosure, a lighting arrangement can include lighting units having wire assemblies of different length. In the implementation shown in FIG. 1, the lighting units 12 and 112 respectively include wire assemblies 18 and 118 that are substantially the same length. The lighting arrangement 10a shown in FIG. 2 includes lighting units 12a having wire assemblies 18a of various lengths and lighting units 112a having wire assemblies 118a of various lengths. The lengths of each wire assembly shown in FIG. 2 is different.

In various implementations of the present disclosure, the relative opacity of the portions of the pendants can be varied as desired. In the implementation shown in FIG. 1, the first portion 22 of the first lighting unit 12 and the first portion 122 of the second lighting unit 112 have the substantially the same opacity. Likewise, the second portion 24 of the first lighting unit 12 and the second portion 124 of the second lighting unit 112 have the substantially the same opacity. The exemplary first portion 22 and exemplary first portion 122 are fully opaque. The exemplary first portions 22, 122 can be black and the exemplary second portions 24, 124 can be white and translucent.

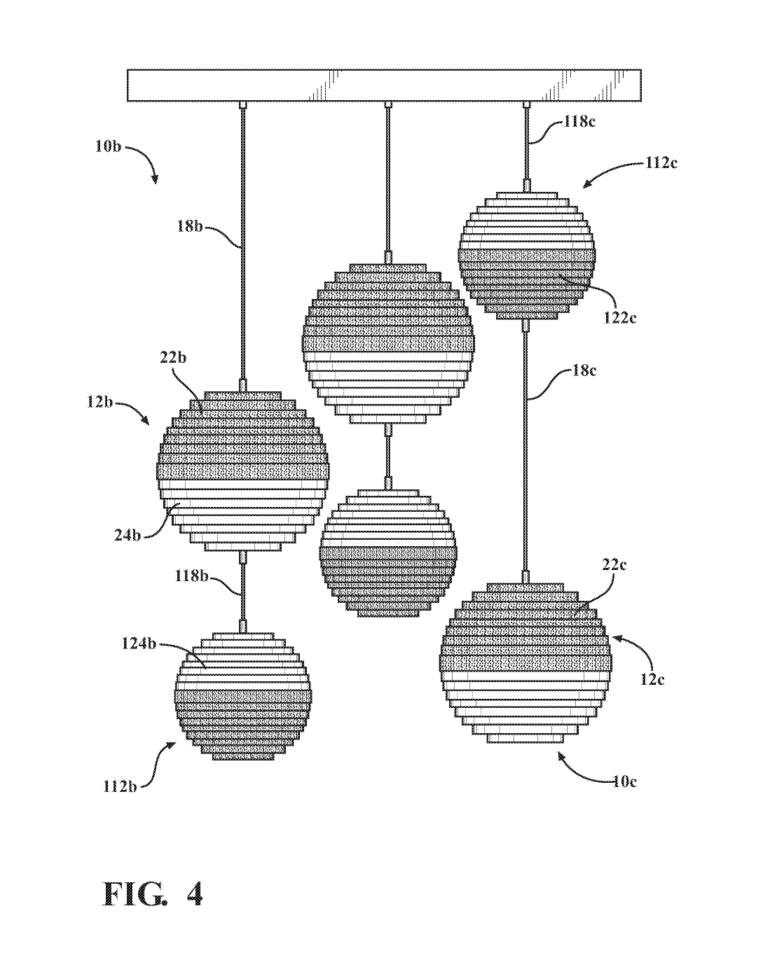

FIG. 4 shows another implementation of the present disclosure. In FIG. 4, a lighting arrangement 10b includes directly interconnected lighting units 12b and 112b. A second wire assembly 118b passes through both of the first and second lighting units 12b, 112b. The second wire assembly 118b passes through second portions 24b, 124b of both of the first and second lighting units 12b, 112b. The wires assemblies 18b, 118b can be in electrical communication with one other such that electrical power is delivered to the wire assembly 118b by the wire assembly 18b.

Also in FIG. 4, a lighting arrangement 10c includes directly interconnected lighting units 12c and 112c. A first wire assembly 18c passes through both of the first and second lighting units 12c, 112c. The first wire assembly 18c passes through first portions 22c, 122c of both of the first and second lighting units 12c, 112c. The wires assemblies 18c, 118c can be in electrical communication with one other such that electrical power is delivered to the wire assembly 18c by the wire assembly 118c.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. The right to claim elements and/or sub-combinations that are disclosed herein as other present disclosures in other patent documents is hereby unconditionally reserved.

What is claimed is:

1. A lighting arrangement comprising:
a first lighting unit including a first light emitting member, a first socket member receiving said first light emitting member, a first wire assembly extending from said first socket member and configured to communicate electricity to said first light emitting member through said first socket member, and a first pendant surrounding said first light emitting member, said first wire assembly configured to support said first light emitting member, said first socket member, and said first pendant in a suspended orientation, said first pendant having portions of different opacity including a first portion and a second portion wherein said first portion is more opaque than said second portion, said first wire assembly passing through said first portion; and
a second lighting unit including a second light emitting member, a second socket member receiving said second light emitting member, a second wire assembly extending from said second socket member and configured to communicate electricity to said second light emitting member through said second socket member, and a second pendant surrounding said second light emitting member, said second wire assembly configured to support said second light emitting member, said second socket member, and said second pendant in a suspended orientation, said second pendant having portions of different opacity including a first portion and a second portion wherein said first portion is more opaque than said second portion, said second wire assembly passing through said second portion.

2. The lighting arrangement of claim 1 wherein said first pendant and said second pendant are substantially similarly sized.

3. The lighting arrangement of claim 1 wherein said first pendant and said second pendant are differently sized.

4. The lighting arrangement of claim 1 wherein said first wire assembly and said second wire assembly are substantially the same length.

5. The lighting arrangement of claim 1 wherein said first wire assembly and said second wire assembly are different lengths.

6. The lighting arrangement of claim 1 wherein said first portion of said first lighting unit and said first portion of said second lighting unit have the substantially the same opacity.

7. The lighting arrangement of claim 6 wherein said second portion of said first lighting unit and said second portion of said second lighting unit have the substantially the same opacity.

8. The lighting arrangement of claim 7 wherein said first portion of said first lighting unit and said first portion of said second lighting unit are fully opaque.

9. The lighting arrangement of claim 8 wherein one of said first and second wire assemblies passes through both of said first and second lighting units.

10. A lighting arrangement comprising:
a first lighting unit including a first light emitting member, a first socket member receiving said first light emitting member, a first wire assembly extending from said first socket member and configured to communicate electricity to said first light emitting member through said first socket member, and a first pendant surrounding said first light emitting member, said first light emitting member and said first socket member and said first pendant suspended with said first wire assembly, said first pendant having portions of different opacity including a first portion and a second portion wherein said first portion is more opaque than said second portion, said wire assembly passing through said first portion; and
a second lighting unit including a second light emitting member, a second socket member receiving said second light emitting member, a second wire assembly extending from said second socket member and configured to communicate electricity to said second light emitting member through said second socket member, and a second pendant surrounding said second light emitting member, said second light emitting member and said second socket member and said second pendant suspended with said second wire assembly, said second lighting unit spaced from said first lighting unit along a horizontal axis, said second pendant having portions of different opacity including a first portion and a second portion wherein said first portion is more opaque than said second portion, said wire assembly passing through said second portion.
